(19) United States
(12) Patent Application Publication
(10) Pub. No.: US 2021/0409876 A1
(43) Pub. Date: Dec. 30, 2021

(54) Method for Adjusting a Hearing Aid Device and System for Carrying Out the Method

(71) Applicant: SONOVA AG, Staefa (CH)

(72) Inventor: Nicola Hildebrand, Uster (CH)

(73) Assignee: Sonova AG

(21) Appl. No.: 17/354,869

(22) Filed: Jun. 22, 2021

(30) Foreign Application Priority Data
Jun. 25, 2020 (EP) EP20182344.0

(51) Int. Cl. H04R 25/00; H04S 7/00; G10L 25/51

(52) U.S. Cl. CPC H04R 25/505; H04S 7/30; G10L 25/51; H04R 2225/41; H04S 2400/11; H04R 2225/55; H04R 25/558

(57) ABSTRACT

A hearing aid device is adjusted based on augmented reality. A virtual sound object, such as a bird, is added to a recording of a real-world environment, such as a tree of a forest. Alternatively, a virtual environment may be added to a real-world sound object. The thereby created acoustic—and optionally also visual—scene is then used to optimize the adjustment of the hearing aid device. The adjustment may be done by a user using at least one user control, such as a volume control.

### RELATED APPLICATIONS

The present application claims priority to EP Patent Application No. 20182344.0, filed Jun. 25, 2020, the contents of which are hereby incorporated by reference in their entirety.

### BACKGROUND INFORMATION

A hearing aid device is a device for aiding an individual in regard to his or her hearing. It may be a hearing prosthesis for compensating a hearing loss, namely an acoustic hearing aid for amplifying sound. Hearing aid devices need to be adjusted to the needs and preferences of their users. The adjustment can be done based on an audiogram by a so-called pre-calculation with a fitting formula. On top of that there can be a so-called fine-tuning. The adjustment can be done by a professional or by the user himself. The adjustment by the professional has the advantage that expensive equipment and more expertise is available. The adjustment by the user has the advantage that it is less expensive and can be done directly in the real-world situation for which it is intended for. Augmented reality is known from applications in military, video games, navigation, healthcare and many others. A game based on augmented reality which is particularly popular is “Pokémon Go”.

The WO 2014/1990086 A2 by Edwards discloses an augmented reality system for use by hearing impaired people. The user is provided with additional visual and auditory information such the name of a person.

The WO 2015/017007 A1 by Pruthi discloses the integration of hearing aids with smart glasses to improve the intelligibility in noise.

The WO 2008/025858 A2 by Boretzki discloses a method for fitting hearing aids by presenting audiovisual scenes comprising sound objects. The sound objects can be selected to perform specific tuning tasks.

The DE 10 20014/218832 A1 by Eckl discloses a method for adjusting a hearing aid using smart glasses. Adjustment parameters are determined based on optical information of a camera.

### BRIEF DESCRIPTION OF THE DRAWINGS

Below, the present technology is described in more detail by referring to the drawings showing exemplified embodiments.

FIG. 1 is a schematic view of a system according to an embodiment of the present technology;

FIG. 2 is a schematic view of a system according to a further embodiment of the present technology; and

FIG. 3 is a diagram illustrating the method according to the present technology.

The described embodiments are meant as examples and shall not confine the present technology.

### DETAILED DESCRIPTION

The present technology relates to the field of hearing aid devices. More particularly, it relates to a method for adjusting a hearing aid device and a system for carrying out the method. The method and the system are based on the principle of augmented reality.

It is a feature of the present technology to provide a method for adjusting a hearing aid device that is advantageous in regard to at least one of the following aspects:

The adjustment should be precise and valid.

The method should be user friendly and entertaining.

It should be possible to carry out the method without expensive equipment.

It should be possible to carry out the method without the help of a hearing care professional.

It should be possible to carry out the method at any place and within any sound environment, even with important sounds, such as the voice of a primary speaker, missing.

It should be possible to do adjustments for different sound situations and acoustic scenes.

It should be possible to do adjustments in multiple dimensions or to do adjustments of multiple sound processing parameters.

It should be possible to find good tradeoffs when there are opposing adjustment objectives which all need to be fulfilled in some extend.

This feature is achieved by the method for adjusting a hearing aid device as described herein. An adjustment based on augmented reality is precise, valid, user friendly and entertaining.

The features described herein are advantageous in that adding at least one virtual sound object allows the adjustment even if an essential sound, such as a primary speaker, is currently missing in the real world.

The features described herein are advantageous in that adding at least two virtual sound objects allows to find good solutions for tradeoffs, when an adjustment should be valid for multiple sounds.

The features described herein are advantageous in that associating sound processing parameters with virtual sound objects allows an efficient target-oriented adjustment of multiple parameters.

The features described herein are advantageous in that virtual sound objects having a virtual location in the real-world environment open up the possibility of a sound parkours. The user may walk through the room and discover different virtual sound objects for specific adjustment tasks.

The features described herein are advantageous in that allowing to add, move and delete the virtual sound objects makes the procedure more interactive and entertaining. This feature may also be part of a game.

The features described herein are advantageous in that combining real-world sound objects with virtual environments allows adjustments of noisy situations, such as in a restaurant, even though the user is currently in a quiet situation.

It is a further feature of the present technology to provide a system for carrying out the methods described herein.

Further embodiments and advantages of the present technology are described with reference to the attached drawings.

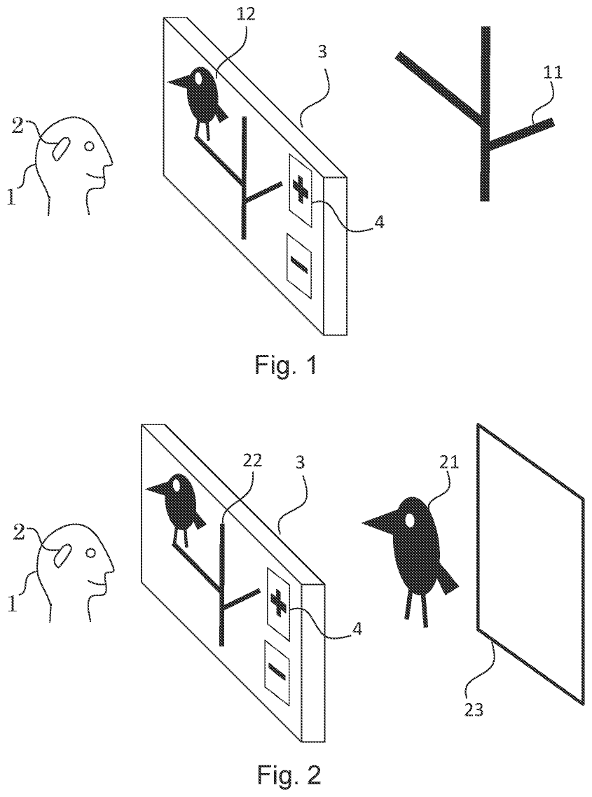

FIG. 1 is a schematic view of a user, an environment and devices according to the present technology. The user 1 is wearing at least one hearing aid device 2. He or she is holding a smartphone 3 such that the camera of it is viewing a real-world environment 11, namely a tree. The image or video feed of the camera is augmented with a virtual sound object 12, namely a bird. The sound of the real-world-environment is combined with the virtual sound of the bird. The user listens to the combined sound via the at least one hearing aid device 2 and adjusts a sound processing parameter of the hearing aid devices 2 with a user control 4.

FIG. 2 is a schematic view, similar to the one of FIG. 1. However, in this case the camera is viewing a real-world sound object 21, namely a bird, which is then augmented with a virtual environment 22, namely a tree. The real-world sound object 21 may be in front of a special background 23, in particular a green or blue screen. This facilitates that suppression of the real-world background 23. However, it is sufficient when the real-world background 23 is static or otherwise predictable, such that it can be computationally suppressed and replaced by the virtual environment 22, in particular by applying artificial intelligence.

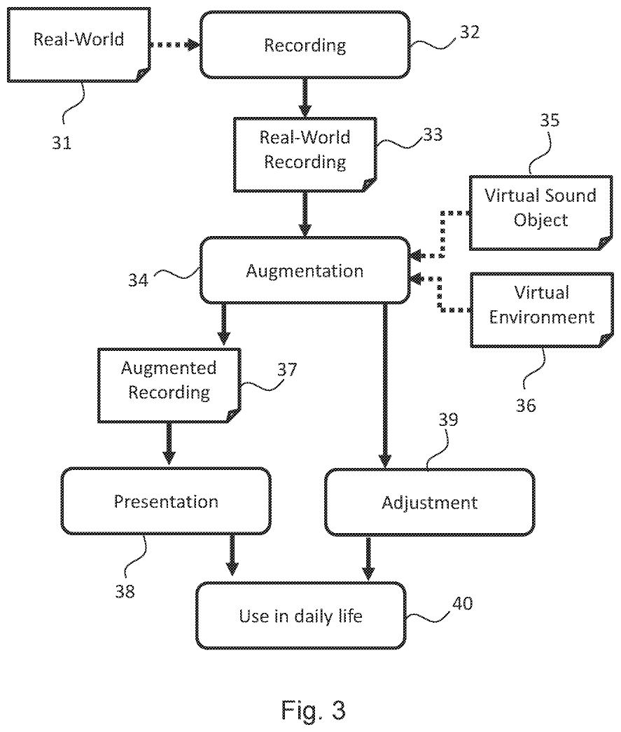

FIG. 3 is a diagram illustrating the method for adjusting at least one hearing aid device according to the present technology. In step 32 a real-world image or video 34 is recorded thereby producing a real-world recording 33. In step 34 the real-world recording is augmented by adding an augmentation 35 and/or 36 thereby obtaining an augmented recording 37. The augmentation 35 is a virtual sound object (case of FIG. 1). The augmentation 36 is a virtual environment (case of FIG. 2). In step 38 the augmented recording 37 is presented to the user. In step 39 at least one sound processing parameter is adjusted by the user using at least one user control. In step 40, the hearing aid devices are used in daily life. All or some of the steps may be carried out simultaneously.

Augmented reality (AR): A real world environment is enhanced by computer-generated perceptual information. According to the present technology, the perception at least in regard to the sense of hearing is enhanced. Optionally, also the visual perception is enhanced. This is different from virtual reality, where there is substantially only computer-generate perceptual information presented to the user.

Hearing aid device: It may be amongst others a conventional acoustic air conduction hearing aid, a bone conduction hearing aid or a cochlear implant electrically stimulating nerve cells, a hearing protection device which helps individuals to hear without damage in noisy environments, a tinnitus treatment device or a hearable. The hearing aid device may be equipped with special sensors, such as movement sensors, location sensors or health sensors.

Additional device: The method can be carried out with sound only, wherein there is no image associated with the virtual sound object or the virtual environment. In this case there is no additional device necessary besides of the at least one hearing aid device. However, there may be a still or moving image. In this case an additional device—or additional devices—with a camera and a display is necessary. It may be amongst others a smartphone, a tablet computer, a head-mounted display, virtual reality glasses, smart glasses or a sufficiently large television set which may be positioned behind a speaker.

System: The at least one hearing aid device and the optional additional device or devices may be referred to as a system.

Hearing aid device user: The individual using the hearing aid device may be an adult, but it may also be an infant or child. It may be a person with or without a hearing impairment.

Virtual sound object: It will usually be in the near field. It may be amongst others a person, a human, a speaker, a teacher, a communication partner, a spouse, a musician, a singer, an actor, a celebrity, a child, a doctor, a hearing care professional, the user him- or herself, a robot, a virtual assistant, a fictional character, a cartoon character, an animal, a bird, a cicada, a dog, a cat, a cow, an elephant, a mouse, a bear, a device, a television set, a jackhammer, a vacuum cleaner, a lawn mower, a radio, a telephone, a musical instrument, a trumpet, a drum, a piano, a flute.

Sound associated with the virtual sound object: It may be amongst others a speech, a voice, a noise and/or music.

Acoustic representation of the virtual sound object: the sound may be presented such that the location of the object (for example left or right and the distance) is perceived realistically.

Visual representation of the virtual sound object: It may be a real-world recording, a drawing or painting, a computer animation, in case of a person an avatar. Sound and image should be synchronous. This facilitates lip-reading.

Virtual environment: It will usually be in the far field. It may be amongst others a room, a living room, a kitchen, a bathroom, a restaurant, a cocktail party, a babble noise situation, a bar, a club, a concert hall, a building, an elevator, a staircase, a church, a museum, a gallery, a zoo, a stadium, a soccer stadium, an ice rink, a bowling alley, a means of transport, a spacecraft, a vehicle, a train, a car, a cab, a bus, a boat, a vessel, an airplane, a gym, an office, a post office, an office of a hearing care professional, a shop, a workshop, a studio, a garage, a repair shop, a pharmacy, a hospital, a nursing home, a school, a library, a waiting room, a mall, an outdoor scene, a street, a forest, a golf course, a tennis court, the moon, another planet, a scene taken from a movie, a scene taken from a computer game, a recording provided by the user him- or herself.

Acoustic representation of the virtual environment: The virtual environment may comprise a plurality of sources, such as multiple people speaking. In some examples, they are all represented such that their location can be perceived realistically.

Visual representation of the virtual environment: It may be a real-world recording or a drawing or painting or a computer animation.

User control: It may be amongst others a mechanical control on the hearing aid devices, such as push buttons, a rocker switch or an adjustment wheel. It may also be a virtual user control displayed on a touch screen as a slider or as a pair of up/down buttons. The user control may be a device for gesture recognition. It may also be a voice command recognition device. There may be multiple user controls, such as in the case of an equalizer.

Sound processing parameter: It may be amongst others volume, left/right balance, tonal balance, noise cancelling, loudness compression, compression steering, frequency compression, frequency lowering, beamforming strength, beamforming direction, sound cleaning algorithm, sound cleaning strength, lows/bass, mids, highs/treble, equalizer, clarity-comfort, degree of loss compensation and acclimatization. It may be a continuous parameter, such as a percentage value, or it may be a discrete parameter, such as an on/off Boolean value or selection from a limited number of choices, such as a hearing program selection or a beamformer selection front, left, right or omni.

A/B-comparisons: The user may be able to store settings of the sound processing parameters and switch between settings for comparing them and determining the best setting.

Tradeoffs: A setting may be good for speech, but not good for music. In some examples, the system supports the user in finding good tradeoffs. This may include switching with a simple button press between two sound situations without changing the sound processing parameters.

Adjustment tasks: The user may be instructed what aspect of the sound should be optimized. An adjustment task may be to maximize “intelligibility”, “comfort” or “naturalness”. An adjustment task may also be to focus on a specific sound source, such as a particular speaker in a plurality of speakers or a specific instrument in an orchestra. Adjustment tasks may be associated with virtual sound objects and displayed as text together with the adjustment controls, when the user selects a virtual sound object. The tasks may also be communicated acoustically. A sound object may be associated with a single or with multiple tasks. There may be a list of tasks to be completed and list of completed tasks or a list with an indication of the completion status of each item. The tasks may be completed in random order or sequentially. The list of tasks may constitute a kind of adjustment parkours.

Adjustment parkours: There may be an adjustment of multiple sound processing parameters incorporating multiple virtual sound objects and/or virtual environments. The user may be guided through such a parkours. Performing adjustment tasks in the way of an adjustment parkours may be especially advantageous in case of children which have a generally smaller attention span. The list of tasks to be completed may be defined by a hearing care professional.

Empowered user: Besides of doing adjustments as prescribed by an adjustment task list or an adjustment parkours, the user may also be able to select adjustment tasks, virtual sound objects and/or virtual environments freely and in random order.

Sound and virtual object data storage device: It may be amongst others a smartphone (3), a tablet computer, a PC, a server, a cloud system.

Real-world environment: The adjustment method according to the present technology may be carried out at any place. For example, it may be carried out in the living room or kitchen of the user. However, it is also possible to carry it out outside, where previously unknown further players may be met or where virtual sound objects positioned by other users may be encountered. It is also possible to carry out the method in the office of a hearing care professional.

Positioning and orientation of a smartphone: By using the GPS, the gyroscope, the acceleration sensors and/or the magnetic compass of the smartphone and further information such as the image viewed by the camera, available WLAN networks the system is capable of determining the position and viewing orientation of the smartphone. This is the prerequisite for correctly displaying the virtual sound objects at their assigned location.

Positioning and orientation of a head-mounted display: A solution called “Holodeck” by Fraunhofer may be used.

Positioning and orientation of the hearing aid devices: The hearing aid devices may be oriented different than the smartphone. The hearing aid device may be equipped with sensors, such that the HRTF can be adapted when the user turns his head, even if the smartphone is not moved.

Head related transfer function (HRTF): Sound can be presented to the hearing aid device user based on a so called HRTF. This is a special filtering which simulates effects such as the head-shadow effect, interaural time differences (ITD) and interaural level differences (ILD). This kind of sound presentation enables directional listening.

Multi-user application: The system may be used by multiple users. A first user may be a hearing-impaired individual wearing the hearing aid devices while a second user may be a significant other or spouse of the first user. The second user may select and place virtual sound objects to be discovered and listened to by the first user. In the case of a multi-user application, there may be a first and a second additional device. The devices may be communicating over the internet. There may also be multiple users (both normal hearing or hearing impaired) competing with each other and/or interacting with each other in a game-like setup.

Second user: The second user may be a so called significant other, a hearing care professional or a further hearing aid device user.

Significant other: It may be a spouse, a caretaker, a teacher or any other person communicating with the hearing aid device user on a regular basis.

Hearing care professional (HCP): The method may be carried out by the hearing aid device user himself. However, he or she may be supported by a professional. It may be an acoustician, an ENT doctor or any other person educated and experienced in the field of hearing care. When fitting hearing aid devices in an office, the method may be used to simulate-real world environments.

HCP office: The office of the HCP may be equipped with different appliances supporting the method according to the present technology. There may be a green or blue background for taking images of people in a way that the background can be computationally replaced. There may be loudspeakers, which may be calibrated. There may be a loudspeaker array for wave filed synthesis.

Virtual sound for the second user: As the second user may not be wearing hearing aid devices, the sound for the second user may be presented over earphones, headphones or loudspeakers. The loudspeakers may form a wave field synthesis system. Earphones or headphones may either be open for real-world sounds, or the real-world sound may be picked up by a microphone, for example of a smartphone and added to the sounds of the augmentation.

Kitchen-use case: The hearing aid device user may want to adjust a restaurant scene without leaving his home. He is talking to his partner (corresponding to the bird in FIG. 2) in the kitchen. The restaurant (corresponding to the tree in FIG. 2) is added visually and acoustically.

Gamification: The goal of the game may be to catch virtual sound objects. Once caught by the user, they may not be available for other users anymore. Points may be awarded not only for catching the virtual sound objects, but also for adjusting the sound produced by them. The game may be similar to a paper chase (German: “Schnitzeljagt”). Multiple player may compete against each other. There may be a high-score list. The hearing aid device user may select an avatar with different attributes such as having a special gender or special clothing.

Audiometry/Diagnostics: The method according to the present technology can be used to carry out an audiometry or a diagnostic of a hearing impairment. It may be a pure tone audiometry for different frequencies of a speech perception audiometry such as a phoneme perception test. The hearing aid device may be adjusted based on the audiometry. A fitting formula such as NAL may be used to convert the audiometric data into a hearing aid fitting.

Feature demonstration: The method according to the present technology can also be used to demonstrate features such as a noise canceller or a beamformer. This may be advantageous if the be benefits of a more expensive hearing aid device are to be presented to a potential hearing device buyer.

What is claimed is:

1. A method for adjusting at least one hearing device by a user comprising the steps of:
recording a current real-world environment thereby obtaining a real-world recording;
augmenting the real-world recording by adding an augmentation thereby obtaining an augmented recording;
presenting the augmented recording to the user; and
adjusting at least one sound processing parameter of the at least one hearing device by the user using at least one user control.

2. The method of claim 1, wherein the augmenting comprises the step of adding at least one virtual sound object to the current real-world environment.

3. The method of claim 2, wherein the at least virtual sound object is at least one of: a person, a human, a speaker, a teacher, a communication partner, a spouse, a musician, a singer, an actor, a celebrity, a child, a doctor, a hearing care professional, the user him- or herself, an avatar, a robot, a virtual assistant, a fictional character, a cartoon character, an animal, a bird, a cicada, a dog, a cat, a cow, an elephant, a mouse, a bear, a device, a television set, a jackhammer, a vacuum cleaner, a lawn mower, a radio, a telephone, a musical instrument, a trumpet, a drum, a piano, a flute, a recording, an animation, a drawing, or a painting.

4. The method of claim 2, wherein there are at least two virtual sound objects, wherein the user enabled to select at least one of them at the time.

5. The method of claim 4, wherein each of the at least two sound objects are each associated with one or more sound processing parameters, which are offered for adjustment, when a particular sound object is selected by the user.

6. The method of claim 2, wherein the at least one virtual sound object has a persistent virtual location in the real-world environment.

7. The method of claim 6, wherein virtual sound objects can be added, moved and/or deleted virtually by the user and/or by a further user.

8. The method of claim 1, wherein the augmenting comprises the steps of:
extracting a real-world sound object from the real-world environment by removing a real-world background and
combining the extracted real-world sound object with a virtual environment.

9. The method of claim 8, wherein the virtual environment is at least one of: a room, a living room, a kitchen, a bathroom, a restaurant, a cocktail party, a babble noise situation, a bar, a club, a concert hall, a building, an elevator, a staircase, a church, a museum, a gallery, a zoo, a stadium, a soccer stadium, an ice rink, a bowling alley, a means of transport, a spacecraft, a vehicle, a train, a car, a cab, a bus, a boat, a vessel, an airplane, a gym, an office, a post office, an office of a hearing care professional, a shop, a workshop, a studio, a garage, a repair shop, a pharmacy, a hospital, a nursing home, a school, a library, a waiting room, a mall, an outdoor scene, a street, a forest, a golf course, a tennis court, the moon, another planet, a scene taken from a movie, a scene taken from a computer game, an animation, a recording, or a recording provided by the user him- or herself.

10. The method of claim 1, wherein the real-world recording comprises an image recorded by a camera comprised in a smartphone, in a tablet computer, in virtual reality glasses or in smart glasses.

11. The method of claim 1, wherein the at least one user control is one or more of the following: a physical user control on the at least one hearing device, a virtual slider displayed on a touchscreen, a push button, a rocker switch, a wheel, a gesture recognition device, or a voice command recognition device.

12. The method of claim 1, wherein the sound processing parameter is one or more of the following: volume, left/right balance, tonal balance, noise cancelling, compression steering, frequency lowering, beamforming strength, beamforming direction, sound cleaning algorithm, lows/bass, mids, highs/treble, equalizer, clarity-comfort, or degree of loss compensation and acclimatization.

13. The method of claim 1, wherein the augmenting comprises the step of streaming sound from a sound storage device to the at least one hearing device, wherein the sound storage device is at least one of a smartphone, a tablet computer, a PC, a server, a cloud system.

14. The method of claim 1, wherein it comprises further the step of the user controlling the augmentation by selecting at least one virtual sound object or at least one virtual environment from a plurality of choices presented to him- or her prior to the augmenting.

15. A system comprising:
at least one hearing aid device;
a smartphone or a tablet computer;
an application running at least partially on the smartphone or the tablet computer, the application configured to carry out the steps of the method of claim 1;
wherein in particular the at least one hearing aid device is one or more of the following: an acoustic hearing aid, a bone conduction hearing aid, a cochlear implant device, or a hearable.
